(19) United States
(12) Patent Application Publication
(10) Pub. No.: US 2010/0280671 A1
(43) Pub. Date: Nov. 4, 2010

(54) DEVICE, SYSTEM AND METHOD THAT DECREASING STANDBY POWER OF ELECTRONIC APPLIANCE AND RECEPTACLE

(76) Inventor: Keun-Jin Lee, Gyeonggi-do (KR)

Correspondence Address: ZARLEY LAW FIRM P.L.C., CAPITAL SQUARE, 400 LOCUST, SUITE 200, DES MOINES, IA, 50309-2350, US

(21) Appl. No.: 12/747,665

(22) PCT Filed: Dec. 12, 2008
(86) PCT No.: PCT/KR08/07369

§ 371 Date: Jun. 11, 2010

(30) Foreign Application Priority Data
Dec. 12, 2007 (KR) 10-2007-0129139
Feb. 28, 2008 (KR) 10-2008-0018499

(51) Int. Cl. G06F 19/00; G06F 1/00; H02B 99/00

(52) U.S. Cl. 700/286; 713/300; 307/126

(57) ABSTRACT

Disclosed are an apparatus, a system and a method for reducing standby power of an electronic appliance, and an apparatus for reducing standby power of an electrical outlet. The apparatus for reducing the standby power of the electronic appliance includes: a starting switch connected to an external power source for providing power from the external power source to the electronic appliance through a first channel, operating the electronic appliance by providing an operation signal for operating the electronic appliance to the electronic appliance, and disconnecting the external power source connected through the first channel; and a power hold switch device connected to the electronic appliance through a second channel, the power hold switch device providing power from the external power source to the electronic appliance through the second channel when receiving a power hold control signal provided by the operating electronic appliance, and disconnecting power provided by the external power source through the second channel when receiving no power hold control signal. As a result, with only one switch operation, the electronic appliance is connected to a power source, and operates at the same time. When a computer (i.e. the electronic appliance) changes from an operating state to a standby state, the power is automatically disconnected from the computer, so that the computer changes to a non-power consuming state. Accordingly, the standby power of the computer is cut by minimizing the standby state thereof, so that it can be minimized.

### TECHNICAL FIELD

The present invention relates to a field related to a technology which can prevent an electronic appliance powered by an external power source from consuming predetermined standby power which is usually consumed even though the electronic appliance is switched off while it is plugged in.

### BACKGROUND ART

The term “standby power” refers to electric power consumed by electrical appliances when they are switched off. Namely, it refers to electrical energy that the electrical appliances consume regardless of whether they are operated, while a user is unaware of the electrical energy consumption. It is also called “Vampire power,” meaning that the electrical appliances continue to draw a small amount of power even when they are switched off.

A solution to the standby power problem is to unplug the unused electrical appliances or to use a multi-tap (i.e. a power strip). This is because the user can obtain the same effect as that of unplugging the electrical appliances when the multi-tap is switched off.

Standby power consumption has been on the rise with the increase of electronic products including display devices which operate by remote control and display operating states of the electronic products. It is estimated that 80% of the entire power consumed by a copier or video recorder is standby power. Examples of electronic products consuming a lot of standby power include computers, monitors, printers, facsimiles, automatic washers, air conditioners, TVs, Digital Versatile Disc (DVD) players, microwave ovens, mobile phone chargers, etc.

The International Energy Agency (IEA) estimates that 60 watts corresponding to 10% of the amount of power consumption per household is standby power in countries which are members of the Organization for Economic Cooperation and Development (OECD). In the United States, standby power consumption accounts for 10% of the amount of power consumption per household and is thus relatively small, but it adds up to about $1.3 billion every year. In order to solve the serious standby power problem as described above, the IEA has advised all countries of the world to reduce standby power-use in all electronic products to less than one watt by 2010.

When being connected to an external power source, a computer needs standby power, and maintains a standby state by using the standby power. Only after a signal is delivered to a computer mainboard via a push switch of the computer in the standby state, the computer is turned on and begins to operate.

Even when the computer is switched off, the computer returns again to the standby state, keeps being connected to the external power source, and consumes predetermined standby power in order to maintain the standby state.

It is premised that an electronic appliances to which the present invention applies include computers, TVs, etc. and have a non-power consuming state, a standby state, and an operating state.

As used herein, the term “non-power consuming state” refers to a state where the power plug of the main body of the TV or computer is left disconnected from an electrical outlet or does not consume standby power at all. In the non-power consuming state, the TV or computer is not powered at all.

The term “standby state” refers to a state where predetermined power is provided to the TV or computer and the main body of the TV or computer stands by in order to receive a start signal from a remote control or a start signal of the computer. When a short signal is generated by a power switch of the TV, which is usually a push switch, and is then delivered to the TV, the TV begins to operate. At this time, the standby state refers to a state where the TV stands by to receive the short signal as described above. Namely, the TV or computer consumes predetermined standby power due to a need for operating either a signal reception unit for receiving the short signal of the power switch and a transmission signal of the remote control or a signal reception unit of the computer mainboard for receiving the start signal of the computer. However, because it is before the electronic appliance performs its original function, the electronic appliance is in a non-operating state thereof.

The term “operating state” refers to a state after pressing the power-on switch of the computer or a state where the TV is turned on by pressing the power-on switch of the remote control.

In order to cut standby power drawn through plugs of the electronic/electrical appliances inserted into an electrical outlet called a “Multi-tap” including at least one plug-socket, a user must pull an inserted plug out of each plug-socket, or turn off a switch mounted in each plug-socket.

### DISCLOSURE OF INVENTION

### Technical Problem

An electronic appliance connected to an external power source consumes standby power for maintaining a standby state thereof before turning on the electronic appliance or after turning it off. The standby power consumption as described above is economic waste, and also raises concerns about increasing the danger of fire.

Accordingly, in order to solve the above-mentioned problems occurring in the prior art, the present invention provides a method and an apparatus which can cut the standby power.

Also, the present invention provides an apparatus for cutting standby power consumed by an electrical outlet including at least one plug-socket and more effectively controlling a power source connected to the electrical outlet.

### Technical Solution

In order to accomplish the above-mentioned objects of the present invention, in accordance with a first aspect of the present invention, there is provided an apparatus for reducing standby power of an electronic appliance, the apparatus including: a starting switch connected to an external power source for providing power from the external power source to the electronic appliance through a first channel, operating the electronic appliance by providing an operation signal for operating the electronic appliance to the electronic appliance, and disconnecting the external power source connected through the first channel; and a power hold switch device connected to the electronic appliance through a second channel, the power hold switch device providing power from the external power source to the electronic appliance through the second channel when receiving a power hold control signal provided by the operating electronic appliance, and disconnecting power provided by the external power source through the second channel when receiving no power hold control signal.

Preferably, the starting switch provides the operation signal before disconnecting the external power source connected through the first channel.

Preferably, the electronic appliance corresponds to a computer, and the power hold control signal corresponds to a power source provided by any of a power supply unit for providing power to the computer, a Peripheral Component Interconnect (PCI) slot of the computer, and an Accelerated Graphics Port (AGP) slot of the computer.

Preferably, the apparatus for reducing the standby power of the electronic appliance includes an electrical outlet having at least one plug-socket, and the electrical outlet is connected to the power hold switch device through the second channel and receives the power from the external power source.

Preferably, the apparatus for reducing the standby power of the electronic appliance includes an object detection sensor for detecting existence of an object, and the object detection sensor is connected to the second channel and connects or disconnects the second channel in such a manner that the power hold switch device provides the power from the external power source to the electrical outlet through the second channel only while detecting the existence of the object.

In accordance with a second aspect of the present invention, there is provided a system for reducing standby power of an electronic appliance, the system including: the electronic appliance, which changes from a non-power consuming state to a standby state when being connected to an external power source, and then changes from the standby state to an operating state when receiving an operation signal, the electronic appliance being disconnected from the external power source and consuming no power in the non-power consuming state, being connected to the external power source and standing by to receive an operation signal in the standby state, and providing a power hold control signal to a power hold switch device in the operating state; a starting switch connected to the external power source and connected to the electronic appliance through a first channel, so that the starting switch changes the electronic appliance from the non-power consuming state to the standby state by connecting the electronic appliance to the external power source through the first channel, changes the electronic appliance from the standby state to the operating state by providing the operation signal to the electronic appliance, and disconnects the external power source to which the electronic appliance is connected through the first channel; and the power hold switch device connected to the external power source and connected to the electronic appliance through a second channel, so that the power hold switch maintains the operating state of the electronic appliance by connecting the electronic appliance to the external power source through the second channel when receiving the power hold control signal provided by the electronic appliance in its operating state, and changes the electronic appliance to the non-power consuming state by disconnecting the connection of the electronic appliance to the external power source through the second channel when receiving no power hold control signal.

Preferably, the starting switch provides the operation signal before disconnecting the external power source connected through the first channel.

Preferably, the electronic appliance corresponds to a computer, and the power hold control signal corresponds to a power source provided by any of a power supply unit for providing power to the computer, a Peripheral Component Interconnect (PCI) slot of the computer, and an Accelerated Graphics Port (AGP) slot of the computer.

Preferably, the power hold control signal corresponds to an internal power source of the electronic appliance provided to the outside by the electronic appliance in its operating state.

Preferably, the system for reducing the standby power of the electronic appliance includes an electrical outlet having at least one plug-socket, and the electrical outlet is connected to the power hold switch device through the second channel and receives power from the external power source.

Preferably, the system for reducing the standby power of the electronic appliance includes an object detection sensor for detecting existence of an object, and the object detection sensor is connected to the second channel and connects or disconnects the second channel in such a manner that the object detection sensor provides the power from the external power source to the electrical outlet through the second channel only when detecting the existence of the object.

In accordance with a third aspect of the present invention, there is provided a method for reducing standby power of an electronic appliance, the method including the steps of: a) connecting the electronic appliance to an external power source through a first channel and changing the electronic appliance from a non-power consuming state, in which no power is consumed by the electronic appliance by disconnection of the power from the electronic appliance, to a standby state, in which the electronic appliance stands by to receive an operation signal for causing the electronic appliance to enter an operating state, and providing the operation signal to the electronic appliance and changing the electronic appliance from the standby state to the operating state, by a starting switch connected to the electronic appliance through the first channel; b) providing the power from the external power source to the electronic appliance through a second channel upon receiving a power hold control signal provided by the electronic appliance in its operating state, by a power hold switch device; and c) disconnecting the connection of the electronic appliance to the external power source through the first channel by the starting switch.

Preferably, the method further includes a step of d) disconnecting the power provided from the external power source to the electronic appliance through the second channel and changing the electronic appliance to the non-power consuming state when the power hold switch device receives no power hold control signal.

Preferably, the electronic appliance corresponds to a computer, and the power hold control signal corresponds to a power source provided by any of a power supply unit for providing power to the computer, a Peripheral Component Interconnect (PCI) slot of the computer, and an Accelerated Graphics Port (AGP) slot of the computer.

In accordance with a fourth aspect of the present invention, there is provided a system for reducing standby power of an electrical outlet, the system including: an electrical outlet including at least one plug-socket; and a signal transmitter for transmitting a connection/disconnection control signal used to connect or disconnect power of the plug-socket, wherein the electrical outlet includes: a plug-socket unit having at least one plug-socket; a communication unit for communicating with the signal transmitter; and a control unit for receiving the connection/disconnection control signal from the signal transmitter, and connecting or disconnecting the power of the plug-socket based on the received connection/disconnection control signal.

Preferably, the signal transmitter includes a computer for executing an application program capable of generating the connection/disconnection control signal.

Preferably, the signal transmitter includes a portable memory, and transmits the connection/disconnection control signal to the electrical outlet with reference to a connection/disconnection control signal and a transmission time point of the connection/disconnection control signal stored in the portable memory.

Preferably, the portable memory corresponds to any of a Secure Digital (SD) memory card, a mini-SD memory card, a Multi-Media Card (MMC) memory card, a Compact Flash (CF) memory card, a Universal Serial Bus (USB) memory, and an external memory mounted on a mobile phone.

Preferably, the plug-socket unit includes at least two plug-sockets, and the connection/disconnection control signal selects at least one plug-socket as sockets to be controlled from among at least two plug-sockets.

### ADVANTAGEOUS EFFECTS

According to the present invention, with only one switch operation, it is possible to connect and provide an external power source to an electronic appliance which is then in a standby state, and simultaneously possible to immediately change the state of the electronic appliance from the standby state to an operating state. Namely, with only one switch operation, a state of the electronic appliance can be instantly changed from a non-power consuming state to the operating state via the standby state.

Also, even when the state of the electronic appliance is changed from the operating state to the standby state by a user's operation, the standby state can be removed from the electronic appliance due to the disconnection of the external power source through a second channel which is caused by the termination of a power hold control signal. Accordingly, the standby power consumed by the electronic appliance in its standby state is cut, so that the standby power of the electronic appliance can be minimized.

Also, the power source can be disconnected from the electrical outlet having at least one plug-socket when, for example, a computer is used to control the electrical outlet. Further, a schedule, such as the time point of disconnecting the power source, etc., can be more conveniently determined by using an application program of the computer. A power source control signal and schedule information as described above are stored in a portable memory which is then inserted into a portable-memory socket of the electrical outlet. With this, the schedule for power source control in the electrical outlet can be more simply and easily controlled.

### BRIEF DESCRIPTION OF DRAWINGS

The foregoing and other objects, features and advantages of the present invention will become more apparent from the following detailed description taken in conjunction with the accompanying drawings in which:

FIG. 1 is a block diagram illustrating a configuration of a system for reducing standby power of an electronic appliance according to an embodiment of the present invention;

FIG. 2 is a block diagram illustrating a configuration of a system for reducing standby power of an electrical outlet according to an embodiment of the present invention;

FIG. 3 is a block diagram illustrating a configuration of a system for reducing standby power of an electrical outlet according to another embodiment of the present invention;

FIG. 4 is a block diagram illustrating a configuration of a system for reducing standby power of an electrical outlet according to still another embodiment of the present invention;

FIG. 5 is a block diagram illustrating a configuration of a system for reducing standby power of an electrical outlet according to yet another embodiment based on the still another embodiment of the present invention as illustrated in FIG. 4;

FIG. 6 is an explanatory view showing a case where an interlocking information transmitter and a signal transmitter include an application program executed by a computer from among exemplary embodiments of the present invention;

FIG. 7 is an explanatory view showing an example of an application program executed by a personal computer as shown in FIG. 6;

FIG. 8 illustrates a circuit diagram according to an embodiment of the present invention;

FIG. 9 illustrates a circuit diagram according to another specific embodiment of the present invention; and

FIG. 10 is a circuit diagram illustrating in detail a starting switch unit of an apparatus for reducing standby power of a computer according to an embodiment of the present invention.

### MODE FOR THE INVENTION

Hereinafter, exemplary embodiments of the present invention will be described with reference to the accompanying drawings.

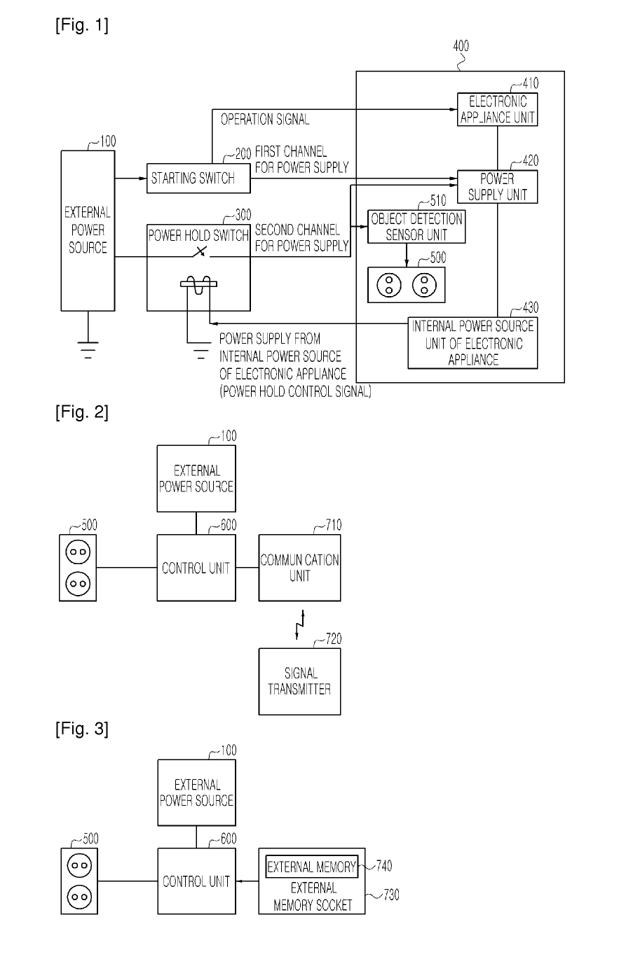

FIG. 1 is a block diagram illustrating a configuration of a system for reducing standby power of an electronic appliance according to an embodiment of the present invention. Referring to FIG. 1, the system of the invention includes an external power source 100, a starting switch 200, a power hold switch 300, the electronic appliance 400, and an electrical outlet 500. The electronic appliance 400 includes an electronic appliance unit 410, a power supply unit 420, and an internal power source unit 430 of the electronic appliance.

The external power source 100 may be a household Alternating Current (AC) power source. A power source provided by the external power source 100 is input to the power supply unit 420 of the electronic appliance 400 through the starting switch 200 and a first channel. The starting switch 200 may be implemented by a push switch. When the starting switch 200 is closed, power is provided to the power supply unit 420 of the electronic appliance 400, and simultaneously, an operation signal is provided to the electronic appliance unit 410. Accordingly, an operation signal reception unit of the electronic appliance unit 410 receives the operation signal. When the starting switch 200 is closed, the state of the electronic appliance 400 changes from a non-power consuming state to a standby state. Upon receiving the operation signal, it changes from the standby state to an operating state. Accordingly, the state of the electronic appliance 400 becomes the standby state by the closing of the starting switch 200, and simultaneously, changes to the operating state. When the electronic appliance 400 operates, power is provided to the internal power source unit 430 of the electronic appliance. The internal power source unit 430 of the electronic appliance, which connects peripheral devices of the electronic appliance 400 to the electronic appliance 400, cannot provide power to another unit in the non-power consuming state or standby state. However, the internal power source unit 430 includes all equivalents capable of providing power to other units in the operating state. In a computer, a power supply terminal for operating the peripheral devices can be given as an example of the internal power source unit 430. Specifically, the internal power source unit 430 may be a Peripheral Component Interconnect (PCI) slot of the computer, which can act as a voltage power source (e.g. 12 volts). An output of the internal power source unit 430 as described above corresponds to a power hold control signal provided by the electronic appliance 400 to which the supply of power from the external power source 100 is maintained. The power hold control signal is output and provided only in the operating state.

A power source provided by the internal power source unit 430 of the electronic appliance is referred to as “internal power source of the electronic appliance” in the present invention. The internal power source of the electronic appliance is connected to an input of the power hold switch 300. When the internal power source of the electronic appliance is input to a control input to the power hold switch 300, the power hold switch 300 operates immediately. When the power hold switch 300 operates, the power supply unit 420 is connected to the external power source 100 through a second channel, and simultaneously, power is provided to the electronic appliance 400.

The power hold switch 300 may be implemented by a relay using a solenoid, a triac, or a Solid-State Relay (SSR).

Namely, immediately after the starting switch 200 provides power to the electronic appliance 400 through the first channel for a short period of time so that the electronic appliance 400 may enter the standby state, the starting switch 200 provides the operation signal to the electronic appliance 400, so that the electronic appliance 400 operates. Then, the internal power source of the electronic appliance 400 in its operating state operates the power hold switch 300, so that the power hold switch 300 provides power to the power supply unit 420 through the second channel. Accordingly, once the operation of the electronic appliance 400 causes the power hold switch 300 to operate, even if the starting switch 200 is again opened so that the external power source through the first channel may be disconnected from the power supply unit 420, power provided to the power supply unit 420 is maintained through the second channel. Therefore, the electronic appliance 400, which has begun to operate, continues to operate.

Meanwhile, there is a case where the state of the electronic appliance 400 changes from the operating state to the standby state due to the completion of an operating system of the computer or reception of a TV turn-off signal while the electronic appliance 400 operates. At this time, the electronic appliance 400 enters the standby state, and consumes standby power. In order to receive a start signal of the electronic appliance 400, the electronic appliance 400 needs to consume the standby power. However, in the present invention, when the electronic appliance 400 stops its operation, the state of the electronic appliance 400 changes to the standby state, the power hold control signal is terminated due to disconnection of the internal power source of the electronic appliance, the power hold switch 300 is disabled, and the external power source provided through the second channel is disconnected. Accordingly, when the operating state of the electronic appliance 400 is completed, the state of the electronic appliance 400 immediately changes to the non-power consuming state without passing through the standby state. Therefore, it is possible to prevent the consumption of the standby power provided to the electronic appliance 400.

Desirably, the end point of the time period during which the starting switch must provide power to the electronic appliance 400 is after a time point when, in the operating state of the electronic appliance 400, the internal power source of the electronic appliance is input to the power hold switch, the power hold switch operates, and the external power source is provided to the electronic appliance 400 through the second channel.

The electronic appliance 400 may be equipped with a separate auxiliary electrical outlet. The separate auxiliary electrical outlet 500 can be used for providing an external power source to peripheral devices of the electronic appliance 400. The separate auxiliary electrical outlet 500 receives the external power source provided by the power hold switch 300 through the second channel. More desirably, the separate auxiliary electrical outlet 500 is equipped with an object detection sensor 510. When a human being exists around the separate auxiliary electrical outlet 500, the object detection sensor 510 determines if a human being exists, and provides the external power source to the separate auxiliary electrical outlet 500 only when the human being exists. The system for reducing the standby power, which includes the separate auxiliary electrical outlet 500 equipped with the object detection sensor, more effectively controls power of the peripheral devices, such as audio systems, printers, monitors, etc., thereby being able to reduce the standby power by a larger amount.

Also, the starting switch may be equipped with an object detection sensor. Accordingly, when the object detection sensor detects the existence of an object, the starting switch 300 connects the electronic appliance 400 to the external power source through the first channel, so that the state of the electronic appliance 400 changes from the non-power consuming state to the standby state. Simultaneously, the starting switch 200 provides the operation signal to the electronic appliance 400, so that the state of the electronic appliance 400 changes from the standby state to the operating state. When a user appears around the object detection sensor, the configuration as described above makes it possible to automatically operate the electronic appliance 400. Also, when the user disappears around the object detection sensor, it makes it possible to automatically stop the operation of the electronic appliance 400 and cut the standby power of the electronic appliance 400.

FIG. 2 is a block diagram illustrating a configuration of a system for reducing standby power of an electrical outlet according to an embodiment of the present invention. Referring to FIG. 2, the system according to an embodiment of the present invention includes the external power source 100, the electrical outlet 500, a control unit 600, a communication unit 710, and a signal transmitter 720.

FIG. 3 is a block diagram illustrating a configuration of a system for reducing standby power of an electrical outlet according to another embodiment of the present invention. Referring to FIG. 3, the system according to another embodiment of the present invention includes the electrical outlet 500, a control unit 600, the external power source 100, an external memory socket 730, and an external memory 740.

The signal transmitter 720 can transmit, to the control unit 600, a connection/disconnection signal for disconnecting or connecting a power source connected to each plug-socket of the electrical outlet 500. Upon receiving the connection/disconnection signal, the control unit 600 connects/disconnects the electrical outlet 500 to/from the power source in response to the received connection/disconnection signal. The signal transmitter 720 can transmit a signal in response to a user's input, or can transmit the connection/disconnection signal according to a predetermined transmission schedule of the connection/disconnection signal. The signal transmitter 720 may be a computer for executing a predetermined application program which transmits the connection/disconnection signal according to a predetermined time point.

The signal transmitter 720 may be implemented by a computer for executing the application program capable of transmitting the connection/disconnection signal. Also, the signal transmitter 720 may be implemented by a portable memory 740 for storing therein information on a connection/disconnection signal of a power source and a connection/disconnection time point. Namely, the information related to the connection/disconnection signal is stored in either a Secure Digital (SD) memory card, a Multi-Media Card (MMC) memory card, or a Compact Flash (CF) memory card. So that the control unit 600 can read information from the SD memory card, the system for reducing the standby power of the electrical outlet is equipped with the external memory socket 730. Accordingly, the control unit 600 reads the power-source connection/disconnection signal information stored in the SD memory card, and controls the connection/disconnection of the external power source of the electrical outlet based on the power-source connection/disconnection signal information.

The connection/disconnection signal information can be encoded, and be stored in the portable memory. In this case, it is possible to prevent using power from plug-sockets of the electrical outlet 500 in an unauthorized manner.

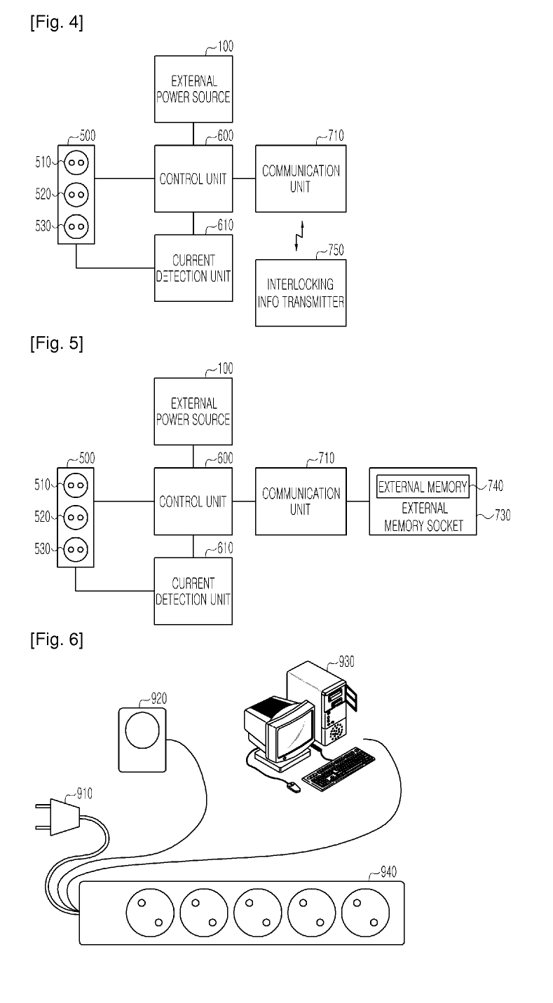

FIG. 4 is a block diagram illustrating a configuration of a system for reducing standby power of an electrical outlet according to still another embodiment of the present invention. Referring to FIG. 4, the system according to still another embodiment of the present invention includes the electrical outlet 500, the external power source 100, a control unit 600, a current detection unit 610, a communication unit 710, and an interlocking information transmitter 750. The interlocking information transmitter 750 generates and transmits interlocking information including information on which plug-sockets are interlocked among any one plug-socket 510 and remaining plug-sockets 520 and 530 of the electrical outlet 500 having at least two plug-sockets 510, 520, and 530. The interlocking information as described above can be generated upon receiving a user's input on a computer. As one embodiment, when the plug-socket 510 must be interlocked with the plug-socket 520, the interlocking information transmitter 750 transmits the interlocking information on interlocking between the plug-socket 510 and the plug-socket 520 to the communication unit 710 of the electrical outlet 500.

Meanwhile, the current detection unit 610 detects a current of each plug-socket of the electrical outlet 500, and provides the detection result to the control unit 600. The control unit 600 maintains power to the plug-socket 520 only when a current of the plug-socket 510 is detected. When a current of the plug-socket 520 is not detected, the control unit 600 disconnects power from the plug-socket 520. The current detection criteria as described above may change according to the type of electronic appliance connected to the plug-socket. Due to the electrical outlet equipped with the interlocking information transmitter 750 as described above, each plug-socket can be more conveniently interlocked. When the interlocking information transmitter 750 can be connected to the communication unit 710 of the electrical outlet 500 by using a Universal Serial Bus (USB) cable, the convenience of a user will increase to a larger extent.

FIG. 5 is a block diagram illustrating a configuration of a system for reducing standby power of an electrical outlet according to yet another embodiment based on the still another embodiment of the present invention as illustrated in FIG. 4. Referring to FIG. 5, the system for reducing the standby power of the electrical outlet 500 includes an external memory socket 730 equipped with the external memory 740, which is different from FIG. 4. Interlocking information, etc. are recorded in a general-purpose external memory, e.g. an SD memory card, so that the interlocking information is delivered to the control unit 600 via the communication unit 710. Namely, the interlocking information transmitter may be implemented by a computer for executing an application program capable of generating interlocking information. Also the interlocking information transmitter may be implemented by a portable memory 740 for storing therein the interlocking information. The interlocking information is stored in the external memory 740, such as the SD memory card, an MMC memory card, a CF memory card, etc.

FIG. 6 is an explanatory view showing a case where the interlocking information transmitter and the signal transmitter include an application program executed by a computer from among exemplary embodiments of the present invention. Referring to FIG. 6, the interlocking information transmitter and the signal transmitter may be implemented by personal computers 930, and an object detection sensor 920 is connected to the system 940 for reducing the standby power of the electrical outlet. The system 940 includes the control unit, the current detection unit, and the communication unit.

When the object detection sensor 920 detects the nonexistence of an object during a predetermined period of time, the application program of the computer 930 is executed so as to disconnect power from a relevant plug-socket with reference to information on a set time and a set plug-socket. Also, the application program of the computer 930 can be executed so as to cut standby power of plug-sockets in such a manner that the set plug-sockets may be interlocked.

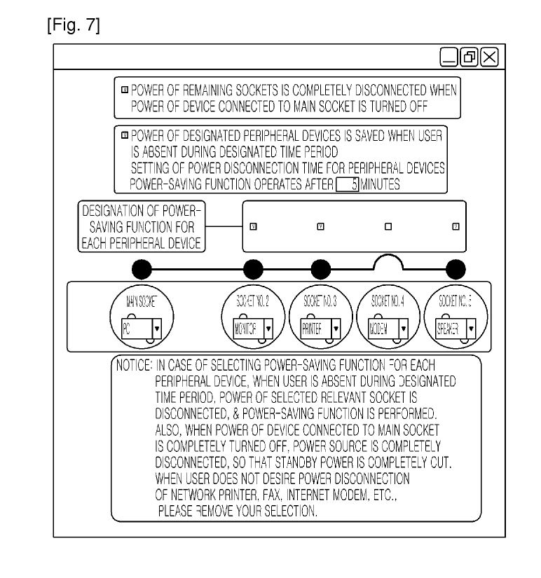

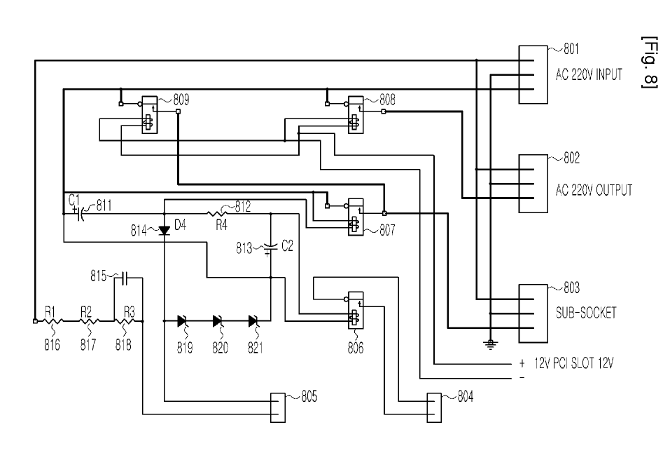

FIG. 7 is an explanatory view showing an example of the application program executed by the personal computer 930 as shown in FIG. 6. In FIG. 7, an interlocking mode becomes ON, and sockets Nos. 2, 3, and 5 are designated as plug-sockets interlocked with a main socket. Also, an automatic power disconnection mode using the object detection sensor is ON, and when an object is not detected for 5 minutes, the sockets Nos. 2, 3, and 5 provide power disconnection signals.

Hereinafter, a description will be made of an embodiment in which the electronic appliance is a computer.

FIG. 8 illustrates a circuit diagram according to an embodiment of the present invention. Referring to FIG. 8, 220V AC is input to an external power source 801, but standby power is not yet consumed. This is because a starting switch 805 is opened. When a user presses the starting switch 805 in order to use a computer, power is provided to both a resistor R3 818 and diodes D1 to D4 819, 820, 821 and 814, and at this time, 12 V is applied to both ends of a capacitor C1 811. This voltage provides power to a relay RL3 807 and a relay RL4 808, and when the relay RL3 807 and relay RL4 808 are turned on, each of a first output power source 802 and a second output power source 803 outputs 220V. The second output power source provides power to a computer mainboard. The relay RL4 808 delivers a start signal to a mainboard start-signal reception unit 804, so that the mainboard operates. When the mainboard operates and the computer is ON, a Peripheral Component Interconnect (PCI) terminal of the computer outputs a power source of 12 V, and the internal power source of 12 V provides power to a relay RL1 809 and a relay RL2 806, so that each of the first output power source 802 and the second power source 803 can maintain 220V. Accordingly, even if the starting switch 805 is again opened, the relay RL1 809 operates, so that the external power can be continuously provided to the computer connected to the second output power source 803. The first output power source 802 is an auxiliary power source to which a peripheral device, e.g. a monitor, is connected.

Meanwhile, when the user turns the computer off with the user's operation such as the shutting down of an operating system, etc., the state of the internal power source of the computer changes to a standby state, so that internal power provided by the PCI terminal is disconnected. At this time, the RL RL1 809 and the relay RL2 806 become off, so that the 220V power source of each of the first output power source 802 and the second output power source 803 is OFF, and all output power sources stop the supply of power. At this time, the standby power becomes 0 watts.

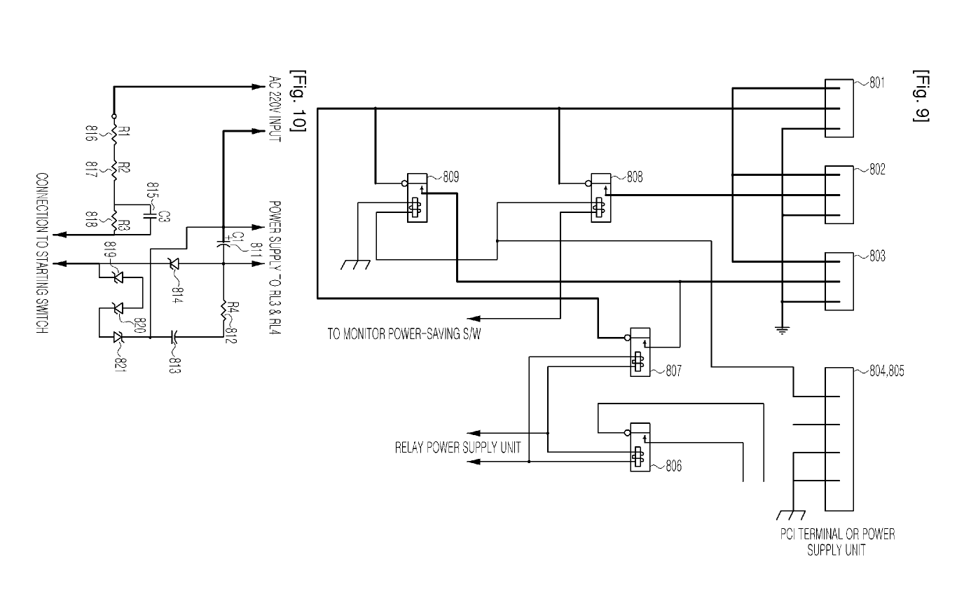

FIG. 9 illustrates a circuit diagram according to another specific embodiment of the present invention. Referring to FIG. 9, control input ends of a relay RL2 806 are connected to a PCI power source, which is an internal power source of a computer, and a separate switch circuit. The separate switch circuit as described above can use a monitor power-source connection/disconnection signal provided by a monitor power-saving program executed by a predetermined computer. Accordingly, even when the internal power source of the computer is not disconnected, the monitor power-saving program can cause a monitor to be OFF, and simultaneously, can cause a control input of the relay RL2 806 to be disconnected in order to turn the relay RL2 806 off. Namely, when the monitor power-saving program causes power of a monitor to be disconnected, it is possible to prevent the relay RL2 806 from operating. Therefore, when the first output power source 802 is used as a power source for the monitor, it is possible to prevent standby power consumption of the monitor by using the monitor power-saving program.

FIG. 10 is a circuit diagram illustrating in detail a starting switch unit of an apparatus for reducing standby power of a computer according to an embodiment of the present invention.

When a user presses a starting switch to turn the computer on, a current of a 220V AC power source passes through a resistor R1 816, a resistor R2 817, a resistor R3 818 and a capacitor C3 815, is provided to a diode D1 819, a diode D2 820, a diode D3 821 and a diode D4 814, and a voltage, which is generated at a capacitor C2 813, a resistor R4 812 and a capacitor C1 811, is a Direct Current (DC) 12V. The generated voltage is determined by the diode D1 819, the diode D2 820, and the diode D3 821. The 12V power source as described above is input to input ends of relays, so that a relay RL3 and a relay RL4 operate. However, when the starting switch is again opened, the 12V power source is disconnected. Accordingly, if the starting switch is again opened, the power source, which is input to the relay RL3 and relay RL4, is disconnected, so that both the relay RL3 and relay RL4 are turned off. However, as described above, before the starting switch is again opened, the internal power source of the computer is provided to the relays RL3 and RL4. Accordingly, it is possible to maintain the power source connected to the relays RL3 and RL4.

### INDUSTRIAL APPLICABILITY

Although several exemplary embodiments of the present invention have been described for illustrative purposes, those skilled in the art will appreciate that various modifications, additions and substitutions are possible, without departing from the scope and spirit of the invention as disclosed in the accompanying claims. Therefore, it is obvious that the scope of the present invention is not determined by the exemplary embodiments as described above, and extends to not only the scope of the appended claims but also the scope of equivalents.

1. A system for reducing standby power of an electronic appliance, the system comprising:
the electronic appliance, which changes from a non-power consuming state to a standby state when being connected to an external power source, and then changes from the standby state to an operating state when receiving an operation signal, the electronic appliance being disconnected from the external power source and consuming no power in the non-power consuming state, being connected to the external power source and standing by to receive an operation signal in the standby state, and providing a power hold control signal to a power hold switch device in the operating state;
a starting switch connected to the external power source and connected to the electronic appliance through a first channel, so that the starting switch changes the electronic appliance from the non-power consuming state to the standby state by connecting the electronic appliance to the external power source through the first channel, changes the electronic appliance from the standby state to the operating state by providing the operation signal to the electronic appliance, and disconnects the external power source to which the electronic appliance is connected through the first channel; and
the power hold switch device connected to the external power source and connected to the electronic appliance through a second channel, so that the power hold switch maintains the operating state of the electronic appliance by connecting the electronic appliance to the external power source through the second channel when receiving the power hold control signal provided by the electronic appliance in its operating state, and changes the electronic appliance to the non-power consuming state by disconnecting the connection of the electronic appliance to the external power source through the second channel when receiving no power hold control signal.

2. The system as claimed in claim 1, wherein the starting switch provides the operation signal before disconnecting the external power source connected through the first channel.

3. The system as claimed in claim 1, wherein the electronic appliance corresponds to a computer, and the power hold control signal corresponds to a power source provided by any of a power supply unit for providing power to the computer, a Peripheral Component Interconnect (PCI) slot of the computer, and an Accelerated Graphics Port (AGP) slot of the computer.

4. The system as claimed in claim 1, wherein the power hold control signal corresponds to an internal power source of the electronic appliance provided to the outside by the electronic appliance in its operating state.

5. The system as claimed in claim 1, wherein the system for reducing the standby power of the electronic appliance comprises an electrical outlet having at least one plug-socket, and the electrical outlet is connected to the power hold switch device through the second channel and receives power from the external power source.

6. The system as claimed in claim 5, wherein the system for reducing the standby power of the electronic appliance comprises an object detection sensor for detecting existence of an object, and the object detection sensor is connected to the second channel and connects or disconnects the second channel in such a manner that the object detection sensor provides the power from the external power source to the electrical outlet through the second channel only when detecting the existence of the object.

7. The system as claimed in claim 1, wherein the starting switch comprises an object detection sensor for detecting existence of an object, and when the object detection sensor detects the existence of the object, the starting switch changes the electronic appliance from the non-power consuming state to the standby state by connecting the electronic appliance to the external power source through the first channel, and changes the electronic appliance from the standby state to the operating state by providing the operation signal to the electronic appliance.

8. An apparatus for reducing standby power of an electronic appliance, the apparatus comprising:
a starting switch connected to an external power source for providing power from the external power source to the electronic appliance through a first channel, operating the electronic appliance by providing an operation signal for operating the electronic appliance to the electronic appliance, and disconnecting the external power source connected through the first channel; and
a power hold switch device connected to the electronic appliance through a second channel, the power hold switch device providing power from the external power source to the electronic appliance through the second channel when receiving a power hold control signal provided by the operating electronic appliance, and disconnecting power provided by the external power source through the second channel when receiving no power hold control signal.

9. The apparatus as claimed in claim 8, wherein the starting switch provides the operation signal before disconnecting the external power source connected through the first channel.

10. The apparatus as claimed in claim 8, wherein the electronic appliance corresponds to a computer, and the power hold control signal corresponds to a power source provided by any of a power supply unit for providing power to the computer, a Peripheral Component Interconnect (PCI) slot of the computer, and an Accelerated Graphics Port (AGP) slot of the computer.

11. The apparatus as claimed in claim 8, wherein the apparatus for reducing the standby power of the electronic appliance comprises an electrical outlet having at least one plug-socket, and the electrical outlet is connected to the power hold switch device through the second channel and receives the power from the external power source.

12. The apparatus as claimed in claim 11, wherein the apparatus for reducing the standby power of the electronic appliance comprises an object detection sensor for detecting existence of an object, and the object detection sensor is connected to the second channel and connects or disconnects the second channel in such a manner that the power hold switch device provides the power from the external power source to the electrical outlet through the second channel only while detecting the existence of the object.

13. The apparatus as claimed in claim 8, wherein the starting switch comprises an object detection sensor for detecting existence of an object; and wherein, when the object detection sensor detects the existence of the object, the starting switch changes the electronic appliance from a non-power consuming state to a standby state by connecting the electronic appliance to the external power source through the first channel, and changes the electronic appliance from the standby state to an operating state by providing the operation signal to the electronic appliance.

14. A method for reducing standby power of an electronic appliance, the method comprising the steps of:
a) connecting the electronic appliance to an external power source through a first channel and changing the electronic appliance from a non-power consuming state, in which no power is consumed by the electronic appliance by disconnection of the power from the electronic appliance, to a standby state, in which the electronic appliance stands by to receive an operation signal for causing the electronic appliance to enter an operating state, and providing the operation signal to the electronic appliance and changing the electronic appliance from the standby state to the operating state, by a starting switch connected to the electronic appliance through the first channel;
b) providing the power from the external power source to the electronic appliance through a second channel upon receiving a power hold control signal provided by the electronic appliance in its operating state, by a power hold switch device; and
c) disconnecting the connection of the electronic appliance to the external power source through the first channel by the starting switch.

15. The method as claimed in claim 14, further comprising a step of d) disconnecting the power provided from the external power source to the electronic appliance through the second channel and changing the electronic appliance to the non-power consuming state when the power hold switch device receives no power hold control signal.

16. The method as claimed in claim 14, wherein the electronic appliance corresponds to a computer, and the power hold control signal corresponds to a power source provided by any of a power supply unit for providing power to the computer, a Peripheral Component Interconnect (PCI) slot of the computer, and an Accelerated Graphics Port (AGP) slot of the computer.

17. A system for reducing standby power of an electrical outlet, the system comprising:
an electrical outlet comprising at least one plug-socket; and
a signal transmitter for transmitting a connection/disconnection control signal used to connect or disconnect power of the plug-socket,
wherein the electrical outlet comprises:
a plug-socket unit having at least one plug-socket;
a communication unit for communicating with the signal transmitter; and
a control unit for receiving the connection/disconnection control signal from the signal transmitter, and connecting or disconnecting the power of the plug-socket based on the received connection/disconnection control signal.

18. The system as claimed in claim 17, wherein the signal transmitter comprises a computer for executing an application program capable of generating the connection/disconnection control signal.

19. The system as claimed in claim 17, wherein the signal transmitter comprises a portable memory, and transmits the connection/disconnection control signal to the electrical outlet with reference to a connection/disconnection control signal and a transmission time point of the connection/disconnection control signal stored in the portable memory.

20. The system as claimed in claim 17, wherein the signal transmitter is connected to the communication unit of the electrical outlet by using a Universal Serial Bus (USB) cable.

21. The system as claimed in claim 19, wherein the portable memory corresponds to any of a Secure Digital (SD) memory card, a mini-SD memory card, a Multi-Media Card (MMC) memory card, a Compact Flash (CF) memory card, a Universal Serial Bus (USB) memory, and an external memory mounted on a mobile phone.

22. The system as claimed in claim 19, wherein the connection/disconnection control signal and the transmission time point of the connection/disconnection control signal are recorded in the portable memory in such a manner as to be encoded.

23. The system as claimed in claim 17, wherein the plug-socket unit comprises at least two plug-sockets, and the connection/disconnection control signal selects at least one plug-socket as sockets to be controlled from among at least two plug-sockets.

24. The system as claimed in claim 17, wherein the signal transmitter comprises an object detection sensor capable of detecting existence of an object, and generates a connection/disconnection control signal based on information on whether the existence of the object is detected during a predetermined period of time and transmits the generated connection/disconnection control signal.

25. A system for reducing standby power of an electrical outlet, the system comprising:
the electrical outlet comprising at least two plug-sockets; and
an interlocking information transmitter for transmitting interlocking information including plug-socket information on another of the at least two plug-sockets, which interlocks along with any of the at least two plug-sockets, to the electrical outlet,
wherein the electrical outlet comprises:
a plug-socket unit having at least two plug-sockets;
a current detection unit for detecting a current of any of the at least two plug-sockets, and generating a disconnection signal when the current is not detected;
a communication unit for communicating with the interlocking information transmitter; and
a control unit for disconnecting power of another of the at least two plug-sockets upon receiving the interlocking information and the disconnection signal.

26. The system as claimed in claim 25, wherein the interlocking information transmitter comprises a computer for executing an application program capable of generating the interlocking information, and the application program can set a control function thereof by using at least one of a power load scheme and an object detection scheme.

27. The system as claimed in claim 25, wherein the interlocking information transmitter comprises a portable memory, and transmits interlocking information stored in the portable memory to the electrical outlet.

28. The system as claimed in claim 25, wherein the interlocking information transmitter is connected to the communication unit of the electrical outlet by using a Universal Serial Bus (USB) cable.

29. The system as claimed in claim 27, wherein the portable memory corresponds to any of a Secure Digital (SD) memory card, a mini-SD memory card, a Multi-Media Card (MMC) memory card, a Compact Flash (CF) memory card, a Universal Serial Bus (USB) memory, and an external memory mounted on a mobile phone.

30. The system as claimed in claim 27, wherein the connection/disconnection control signal and a transmission time point of the connection/disconnection control signal are recorded in the portable memory in such a manner as to be encoded.
